(19) United States
(12) Patent Application Publication
(10) Pub. No.: US 2026/0180700 A1
(43) Pub. Date: Jun. 25, 2026

(54) USER EQUIPMENT ASSISTED JAMMING DETECTION

(71) Applicant: Telefonaktiebolaget LM Ericsson (publ), Stockholm (SE)

(72) Inventors: Henrik Forssell, Enskede (SE); Hugo Tullberg, Nyköping (SE); Guido Carlo Ferrante, Stockholm (SE)

(21) Appl. No.: 19/125,817

(22) PCT Filed: Oct. 31, 2022
(86) PCT No.: PCT/SE2022/050997

§ 371 Date: Apr. 30, 2025

(51) Int. Cl. H04B 17/309; H04B 7/06; H04K 3/00; H04L 5/00; H04W 24/10

(52) U.S. Cl. CPC H04B 17/346; H04B 7/0626; H04K 3/222; H04L 5/0051; H04W 24/10; H04K 2203/16

(57) ABSTRACT

A User Equipment (UE)-assisted jamming detection system in a telecommunications network is disclosed herein. In one embodiment, a method performed by a network node implementing a UE-assisted jamming detection system of a telecommunications network comprises receiving a plurality of UE measurement reports from a corresponding plurality of UEs. The method further comprises categorizing each UE measurement report of the plurality of UE measurement reports into a spatial bin of a plurality of spatial bins. The method also comprises, based on the plurality of spatial bins, identifying a presence of a jamming source in one or more spatial bins of the plurality of spatial bins. Network nodes are also disclosed.

### TECHNICAL FIELD

The present disclosure relates to a method performed by a network node implementing a User Equipment (UE) assisted jamming detection system. Network nodes are also disclosed.

### BACKGROUND

Deliberate interference aimed at disrupting wireless communication, also known as radio jamming, poses a serious threat to mobile radio access networks (RANs), especially considering their application to critical use cases such as industrial automation, autonomous vehicles, and mission-critical communications where trustworthiness is one of the key enablers. Despite being illegal to possess or use in most countries, equipment for radio jamming can easily be bought commercially on the internet or assembled using software defined radios (SDR). Additionally, while most commercial jamming equipment is continuously emitting energy in a certain frequency band (so-called “barrage jammers”), the availability of SDRs and open-source implementations of Long Term Evolution (LTE) and New Radio (NR) causes concern that more sophisticated jamming methods (e.g., targeting physical (PHY) layer synchronization or control signals) are future threats towards RANs. For these reasons, jamming is one of the high priority threats targeting a Radio Access Network (RAN) air interface, and enhanced resilience against these types of attacks is necessary for the trustworthiness of current and future mobile communication standards.

The problem of securing RANs against jamming attacks can partly be solved with resilient design of PHY-layer protocols, as well as jamming-combating techniques such as frequency hopping, subcarrier blanking, or adaptive interference cancellation. However, deployment of such mitigation techniques is usually associated with costs in terms of communication overhead, spectral efficiency, and system complexity. Therefore, to be able to efficiently deploy mitigation techniques only when they are needed, the RAN needs jamming detection systems to accurately detect and differentiate jamming signals from regular interference, and potentially even classify the type of jamming transmitter. Information from such automated detection of jamming events can either be used to notify operators about the ongoing attack, or serve as input to closed-loop security automation systems that automatically deploy the appropriate mitigation techniques.

Existing solutions for detection of jamming attacks in RAN can broadly be divided into three categories: (i) standalone detection systems, (ii) physical layer detection schemes, and (iii) performance management (PM) based detection schemes. Standalone detection systems operate independently of the RAN, and monitor the spectrum while searching for jamming signal characteristics. Upon detecting a jamming attack, the standalone detection system could either notify system operators or give automated feedback to the RAN. Physical layer detection approaches are based on processing of received PHY-layer signals (i.e., IQ samples) in the RAN air interface. The detection algorithms used in physical layer detection approaches can resemble those of standalone detection systems, with the difference being that the algorithms are implemented within the regular PHY-layer processing in the base station. Finally, PM-based methods are based on monitoring network PM data such as PM events, counters, and key performance indicators (KPIs) to detect anomalous network behaviors that indicate the presence of a jamming attack.

The document by H. Pirayesh and H. Zeng, “Jamming Attacks and Anti-Jamming Strategies in Wireless Networks: A Comprehensive Survey,” in IEEE Communications Surveys & Tutorials, vol. 24, no. 2, pp. 767-809, 2022, discloses a review of jamming and anti-jamming strategies.

### SUMMARY

A method and network nodes are disclosed herein for implementing a User Equipment (UE)-assisted jamming detection system in a telecommunications network. Embodiments of a method performed by a network node implementing a UE-assisted jamming detection system of a telecommunications network are disclosed herein. The method comprises receiving a plurality of UE measurement reports from a corresponding plurality of UEs. The method further comprises categorizing each UE measurement report of the plurality of UE measurement reports into a spatial bin of a plurality of spatial bins. The method also comprises, based on the plurality of spatial bins, identifying a presence of a jamming source in one or more spatial bins of the plurality of spatial bins.

In some embodiments, the network node comprises a New Radio (NR) node B (gNB). Some embodiments may provide that the method further comprises configuring sounding reference signals (SRS) with a specific pattern to match the plurality of spatial bins. In such an embodiment, the method also comprises triggering each UE of the plurality of UEs to transmit in periodic or aperiodic fashion. According to some embodiments, receiving the plurality of UE measurement reports from the corresponding plurality of UEs comprises receiving the plurality of UE measurement reports from one or more New Radio (NR) gNBs. In some embodiments, each UE measurement report of the plurality of UE measurement reports comprises a signal-to-interference-and-noise ratio (SINR) measurement calculated based on a secondary synchronization signal (SSS), a SINR measurement based on a Channel State Information (CSI) reference signal, or a cross-link interference (CLI) measurement. Some such embodiments may provide that the method further comprises configuring Radio Resource Control (RRC) for periodic measurement with a reporting period defined by a variable reportInterval, wherein identifying the presence of the jamming source in one or more spatial bins of the plurality of spatial bins comprises comparing a collected measurement for the one or more spatial bins within a given time window with a pre-specified threshold. According to some such embodiments, the method further comprises RRC for event-based reporting, wherein identifying the presence of the jamming source in one or more spatial bins of the plurality of spatial bins comprises comparing a count of reported events for the one or more spatial bins within a given time window with a pre-specified threshold.

In some embodiments, categorizing each UE measurement report of the plurality of UE measurement reports into the spatial bin of a plurality of spatial bins is based on a serving cell of the UE, a sector of the UE, a beam of the UE, or a spatial position of the UE. Some embodiments may provide that the method further comprises, responsive to identifying the presence of the jamming source in the one or more spatial bins of the plurality of spatial bins, generating an alarm to an operator of the telecommunications network or to law enforcement. According to some embodiments, the method further comprises, responsive to identifying the presence of the jamming source in the one or more spatial bins of the plurality of spatial bins, triggering a more fine-grained jamming detection and classification algorithm in the telecommunications network. In some embodiments, the method further comprises, responsive to identifying the presence of the jamming source in the one or more spatial bins of the plurality of spatial bins, determining a position of the jamming source. Some embodiments may provide that the method further comprises, responsive to identifying the presence of the jamming source in the one or more spatial bins of the plurality of spatial bins, providing an indication of the presence of the jamming source as an input to trigger an automated response or an automated mitigation action. According to some embodiments, identifying the presence of the jamming source in the one or more spatial bins of the plurality of spatial bins is based on a machine learning (ML) algorithm.

Embodiments of a network node implementing a UE-assisted jamming detection system of a telecommunications network are also disclosed herein. The network node a network interface, and processing circuitry associated with the network interface. The processing circuitry is configured to cause the network node to receive a plurality of UE measurement reports from a corresponding plurality of UEs. The processing circuitry is further configured to cause the network node to categorize each UE measurement report of the plurality of UE measurement reports into a spatial bin of a plurality of spatial bins. The processing circuitry is also configured to, based on the plurality of spatial bins, identify a presence of a jamming source in one or more spatial bins of the plurality of spatial bins. According to some embodiments, the processing circuitry is further configured to cause the network node to perform any of the operations/embodiments of the method above and performed by any one of the network nodes above.

Embodiments of a network node implementing a UE-assisted jamming detection system of a telecommunications network are also disclosed herein. The network node is adapted to receive a plurality of UE measurement reports from a corresponding plurality of UEs. The network node is further adapted to categorize each UE measurement report of the plurality of UE measurement reports into a spatial bin of a plurality of spatial bins. The network node is also adapted to, based on the plurality of spatial bins, identify a presence of a jamming source in one or more spatial bins of the plurality of spatial bins. In some embodiments, the network node is further adapted to perform any of the operations/embodiments of the method above and performed by any one of the network nodes above.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a system overview for a UE-assisted jamming detection solution, according to some embodiments of the present disclosure;

FIG. 2 illustrates a communications flow of UE measurement reports according to some embodiments of the present disclosure;

FIGS. 3A and 3B illustrate exemplary operations for implementing UE-assisted jamming detection, according to some embodiments of the present disclosure;

FIG. 4 illustrates one example of a cellular communications system according to some embodiments of the present disclosure;

FIG. 5 is a schematic block diagram of a radio access node according to some embodiments of the present disclosure;

FIG. 6 is a schematic block diagram that illustrates a virtualized embodiment of the radio access node of FIG. 5 according to some embodiments of the present disclosure;

FIG. 7 is a schematic block diagram of the radio access node of FIG. 5 according to some other embodiments of the present disclosure;

FIG. 8 is a schematic block diagram of a User Equipment device (UE) according to some embodiments of the present disclosure; and

FIG. 9 is a schematic block diagram of the UE of FIG. 8 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenges with conventional approaches. Standalone detection systems are obviously beneficial in the sense that they have a minimal footprint and impact on the RAN architecture. However, to enable operator notifications and/or closed-loop security automation workflows, the information from standalone detection systems need to be provided to the RAN through appropriate interfaces. Moreover, feedback to standalone detection systems is necessary to tune the detection receiver to the appropriate frequency bands that are used by the RAN. To what extent such interfaces can be standardized remains an open challenge, especially considering that standalone detection systems could be built by different manufacturers using different algorithms.

Physical layer detection schemes use the most fine-grained information available for the jamming detection problem, and are thus the most reliable in terms of detection accuracy. In these schemes, the challenges are instead related to memory and processing footprint or data collection and management. Firstly, locally and continuously scanning physical layer samples for jamming signals comes with a significant cost in terms of computational resources, overhead, and memory. Such issues can partly be alleviated by reusing existing PHY-layer processing (e.g., Fast Fourier Transforms (FFTs)) as much as possible, and by only applying the algorithms to a subset of the IQ sample stream. With a more centralized approach, the issue is that streaming of IQ sample data from multiple cells to a centralized detection system would require huge amounts of network bandwidth. Due to these problems, a physical layer detection method can be impractical for serving as an independent system for jamming detection in a RAN, but would rather be used for root-cause analysis or be automatically triggered by higher layer detection systems indicating a likely presence of jamming.

PM-based detection methods rely on network PM data, such as counters and events, to detect signatures that are caused by jamming interference. There are currently multiple PM counters and events in existing products related to interference and service availability that could be utilized for jamming detection. However, these measurements also have several limitations related to resolution and availability. First, the PM data has lower time resolution than the IQ samples, and is thus expected to have lower detection accuracy. This causes the fine-grained signatures of the jamming transmitters to not be visible in the PM data, which could lead to a problem of differentiating the deliberate jamming signals from regular network interference (e.g., due to high load). Moreover, detection methods using this kind of data will be highly dependent on counter and event implementations. For instance, cell-level aggregation of counters would make it difficult to exploit beamforming to localize the jammer, and changes in counter implementations could require frequent re-tuning of the jamming detection algorithms. Finally, the PM data collection procedure may be limited by the report output period (ROP), which significantly increases the time-to-detection of a jamming detection system using this data.

Another issue with algorithms based on data recorded at a base station site, such as a site that includes one or more gNodeBs (gNBs), is that even low-power jammers can have a significant impact on the communication performance if the jammer is located close to a UE. In such cases, the jammer will degrade the UE's reception performance, potentially both in channel estimation and in data reception. However, this kind of local jammer will be difficult to detect by algorithms that analyze physical layer signals at the base station site (either standalone or part of the RAN) due to the low received power from the jammer.

Certain aspects of the disclosure and their embodiments may provide solutions to these or other challenges. A disclosed solution exploits UE measurement reports to detect radio jamming in NR radio access networks, effectively using the UEs as distributed jamming sensors through the standardized measurement reports that contain useful information on the channel quality and at least one interference level in each UEs immediate environment. Based on analysis of measurement report data from multiple UEs, aspects disclosed herein search for patterns in UE interference measurements (e.g., a subset of UEs experiencing abnormal interference conditions) that might indicate the presence of a jamming source such as a jamming transmitter.

Note that, while the focus is on NR specifications on UE measurement reports, part of the described approach can apply to LTE. In general, aspects disclosed herein are applicable to any current or future cellular system with distributed communication devices.

Depending on the UE capabilities, the solution can be based on different types of UE measurements. One option in some embodiments is the SS-SINR measurement, i.e., the signal-to-interference-and-noise ratio calculated based on the secondary synchronization signal (SSS), which will decrease for UEs in the presence of most types of jammers. Measuring interference on the SSS is beneficial for the problem considered since synchronization signals are likely targets for various smart jamming strategies. Another option according to some embodiments is the CSI-SINR measurement that is based on the Channel State Information (CSI) reference signals. However, both SS-SINR and CSI-SINR are optional UE capabilities and might not be available in all scenarios. A third option is the cross-link interference (CLI) measurements, originally used for detecting uplink interference from other base stations (e.g., other operators or out-of-band emissions).

The solution disclosed herein is based on creating bins of UE measurements used for calculating statistics (e.g., an average or cumulative density function) that are used for hypothesis testing. The bins are defined based on each UE's serving cell, sector, or spatial position (that is, if UE position information is available) and the detection algorithm is based on threshold detectors. In the considered setup, detector thresholds need to be tuned to appropriate levels, trading between the probabilities of Type-I (i.e., a false alarm) and Type-II (i.e., a missed detection) errors. Note that while the focus of aspects disclosed herein is on the appropriate measurement data and detection based on statistical threshold-based hypothesis testing, some examples may include machine learning (ML) tools for detection or tuning appropriate thresholds.

The UE-assisted jamming detection system disclosed herein may be used as an independent solution (e.g., to provide alarms to the RAN operator or law enforcement), or may be integrated with other jamming detection solutions. As an example of the latter case, the UE-assisted detector can serve as an initial trigger for more fine-grained jamming detection and classification algorithms in the RAN (e.g., based on baseband or PM data from the gNB), and/or as an input to trigger an automated response or an automated mitigation action. Moreover, the UE-assisted jamming detection system can provide a coarse-level positioning of the jamming source that can be useful for efficient mitigation of the threat (e.g., by gathering measurement reports from several UEs in a geographical region and then using that data for localization purposes).

Certain embodiments may provide one or more of the following technical advantage(s). First, a RAN-integrated solution for jamming detection can be deployed as a software service running on existing platforms, thus reducing operator and/or societal costs for external hardware in standalone systems. Moreover, as the solution exploits existing UEs as distributed sensors, there is reduced need for standalone jamming-sensor equipment in the network. Secondly, the RAN footprint of the solution is limited, since UE measurement reports are already implemented for other purposes such as cell selection and handovers. Finally, the UE-assisted detection system can more effectively detect low-power jammers in the vicinity of the UEs, as opposed to solutions using baseband or PM data that can suffer from poor detection performance for low-power jammers due to the low received power at the base station/gNB site.

Before discussing UE-assisted jamming detection in a telecommunications network in greater detail, the following terms are first defined:

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node, device, or apparatus in a core network of a 3GPP wireless network or any node, device, or apparatus that implements a core network function in a 3GPP wireless network. Some examples of a core network node include a server host that comprises, e.g., a Mobility Management Entity (MME), a Packet Data Network Gateway (P-GW), a Service Capability Exposure Function (SCEF), a Home Subscriber Server (HSS), or the like in a 3GPP Evolved Packet Core (EPC). Some other examples of a core network node include a server host which implements an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like in a 3GPP 5G core network (5GC).

Communication Device: As used herein, a “communication device” is any type of device that has access to an access network. Some examples of a communication device include, but are not limited to: mobile phone, smart phone, sensor device, meter, vehicle (e.g., an uncrewed aerial vehicle; a road vehicle, such as a car, a bus, and a truck; a train, a boat and a aircraft), household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Some of the embodiments contemplated herein will now be described more fully with reference to the accompanying drawings. Embodiments are provided by way of example to convey the scope of the subject matter to those skilled in the art.

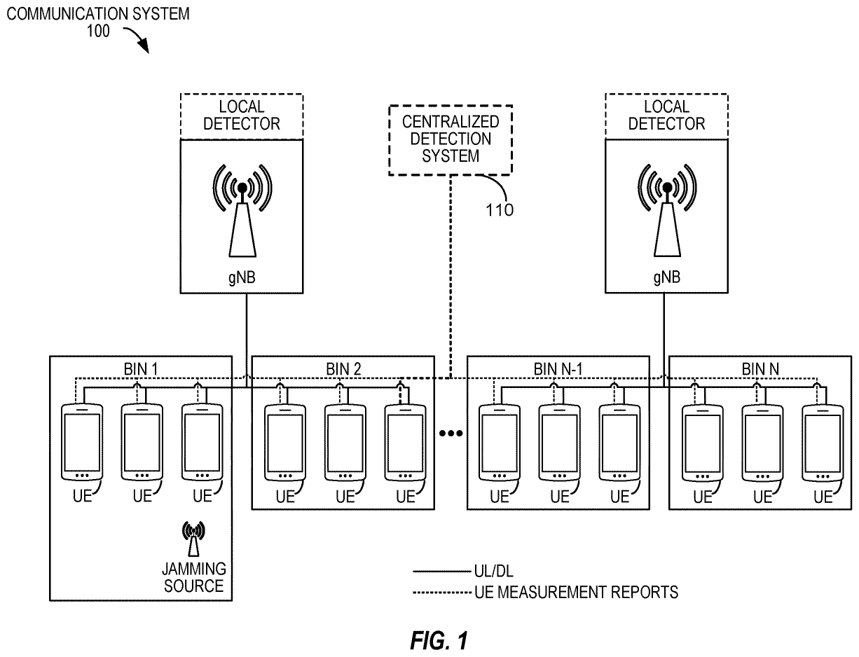

An example of a system overview for the UE-assisted jamming detection solution can be seen in FIG. 1. The considered system consists of multiple UEs and gNB sites. The UEs are associated with gNBs as usual in 5G NR. Additionally, there is a jamming source present, attempting to disrupt communication between one or more UEs and their associated gNB(s).

The detection system collects UE-measurement reports that can comprise conventional reports that already exist in the system such as SS-SINR or CSI-SINR measurement reports. Moreover, by leveraging different CSI-RS configurations done by gNB, each UE can measure Channel Quality information (CQI), precoder matrix indicator (PMI), CSI-RS resource indicator (CRI), SS/PBCH Block Resource indicator (SSBRI), layer indicator (LI), rank indicator (RI), L1-RSRP or L1-SINR. Further, there exists CSI-IM, which is a set of specific resource elements reserved for interference measurement. In addition to these examples, new UE measurements can be specified by future standards for the specific jamming detection use case.

The collected reports are categorized into N spatial bins, with each bin representing a cell, sector, beam, or other spatial area. Categorizing measurements according to a given spatial area can be beneficial for positioning of the jamming source (however, note that such a solution is more complex as it requires UE position data). If precise UE position is not available, beam number or estimated angle of arrival can be used to provide an approximate angular position, and timing advance or time of flight can be used to provide a radial position. As used herein, the terms “spatial bin” and “bin” each refers to a category, related to a distinct spatial area, into which data reported by UEs may be organized. It is to be understood that, while the terms “spatial bin” and “bin” are used throughout this disclosure, other terms such as are “spatial group,” “area group,” “spatial bucket,” “spatial slot,” or “spatial class,” may be considered as having the same definition as used for “spatial bin” or “bin” herein, and thus may be used interchangeably.

In some embodiments, the categorization of UE-reported data into spatial bins may involve two elements: (1) a database that comprises definitions of each spatial bin (based on, e.g., certain specified ranges of values, examples of which are discussed in greater detail below); and (2) a process that receives each UE measurement report and associated position data, and applies a rule-based analysis of the measurement report according to the rules in the database to determine into which spatial bin the measurement report should be categorized. Some such embodiments may provide that the database comprises a repository of rules, such as a lookup table or hash table, that maps specified value ranges of location-related variables to a corresponding bin index. According to some such embodiments, the rules may specify how each UE measurement report is categorized, and/or may provide additional specifications such as limiting categorization only to UEs associated with specified cells. The rules defining categorization into bins are configured to ensure that each UE measurement report is mapped to only one spatial bin.

Some examples of rule definitions according to such embodiments may include the following:
A. UE position estimate or GPS positioning: According to this rule, a report is categorized into a particular Bin Z if estimated positional (x,y) coordinates with respect to the gNB falls within a region, denoted by coordinates x₁, y₁ and x₂, y₂, such x₁<x<x₂ and y₁<y<y₂;
B. Beam and time-of-flight (TOF): According to this rule, a report is categorized into a particular Bin Z if the UE sending the report is on a receive beam X and the TOF falls within a time interval, denoted by time indicators t₁ and t₂, such that t₁<TOF<t₂
C. Cell ID (in embodiments employing centralized detection): According to this rule, a report is categorized into a particular Bin Z if the UP sending the report UE is connected to a specified Cell X.

In another embodiment, the gNB may explicitly configure the SRS with a specific pattern to match the N spatial bins, and may trigger the UE to transmit in either periodic or aperiodic fashion. Then, the gNB can process the SRS to detect the presence of the jamming source in the interior of the coverage region (e.g., closer to the gNB).

FIG. 1 illustrates two possible options for deployment of detection logic. The first option is to use local detectors, i.e. local UE-assisted jamming detection systems deployed as independent software modules in each gNB (e.g. as illustrated in FIG. 7), that only consider UE measurement data of subscribers within the coverage area of the cell. The local detector can detect jamming interference affecting a subset of UEs connected to the gNB. The second option is a more centralized detector (e.g., in either an edge or remote cloud), i.e. a centralized UE-assisted jamming detection system 110, that collects UE measurements from multiple sites. Centralized detection logic has the benefit of being able to coordinate jamming detection across multiple cells. Other options are also possible. It is to be understood that the location of the detection logic is a trade-off between computational load, delay, backhaul requirements, and the like, and thus may vary according to the needs of specific implementations.

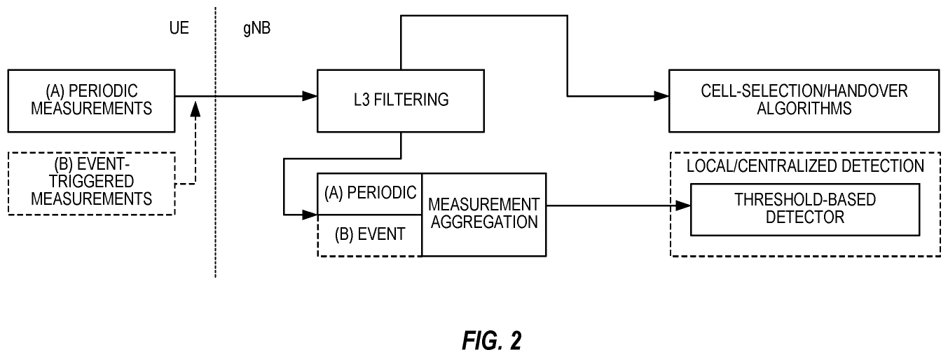

The flow of the UE measurement reports in some embodiments can be viewed in FIG. 2. Depending on the RRC measurement configuration, the UE reports either (a) periodic measurements according to a specified reporting period or (b) measurement triggered by certain events (e.g., value below specified threshold). The typical measurement procedure includes filtering of the received UE measurements to remove the effect of outliers and the filtered measurements are then used in regular cell-selection and handover algorithms. The jamming detection solution proposed herein operates in parallel, consumes the filtered measurements, and aggregate them according to the measurement bins. Finally, the aggregated measurements are used as input to the threshold-based jamming detector module. Note that the measurements, events, and L3 filtering described here are based on 3GPP technical specification 38.331, e.g. Version 16.9.0, and no additional measurements are required for the presented detection solution.

For periodic configuration of UE-assisted jamming detection, the RRC configuration should be set to periodical measurement with reporting period defined by the variable reportInterval, which can be configured to values between 120 ms and 30 min. The reference signals used for measurements are either SSB or CSI-RS, or another suitable signal.

In the case of barrage jamming (i.e., a continuous interference signal transmitted in the deployed frequency band), the jammer will cause similar impact on both SSB and CSI-RS measurements. On the other hand, attacks based on smart jamming strategies (e.g., jamming only synchronization signals) might influence only SSB-based measurements and in such situations the RRC measurement configuration is important.

If the existing reports and corresponding report intervals are not sufficiently granular to catch some relevant jammer event, new measurements and reports can be specified in the standard.

Measurement-driven detection in some embodiments is now discussed. With periodic RRC measurement configuration, the UE-assisted detection solution processes received interference measurements (i.e., SS-SINR, CSI-SINR, or RSRQ measurements) over a specified time window. For example, the periodic SS-SINR measurement values are reported as a code value in the range of 0-127 representing SINR values-23 dB to 40 dB with a resolution of 0.5 dB at every time interval defined by reportInterval. The collected measurement for a given bin and time window is used to make a threshold-based decision on the presence of jamming interference. A simple detector can be designed by comparing the average reported SINR to a pre-specified threshold.

Event-driven detection according to some embodiments is now discussed. With RRC configured to event-based reporting, the detection system instead collects reported measurement events. There are two events specified in 3GPP TS 38.331 that are relevant for the jamming detection system:
Event A2: Serving becomes worse than threshold
Event L1: Interference becomes higher than threshold

With event-driven detection, the detection system counts the number of events collected over a given bin and time window. Detection occurs if the number of counted events exceed a pre-specified threshold.

KPI-based triggering of UE measurements in some embodiments is now discussed. In scenarios where periodic UE measurements is not feasible, the solution disclosed herein can be activated by some other triggering mechanism. For instance, a centralized jamming detection system that evaluate appropriate network KPIs to detect likely presence of jamming interference can provide the initial triggering. Based on the trigger, the gNB sends out RRC measurement configuration and activates the periodic UE measurements and the UE-assisted jamming detection system.

In some embodiments, machine learning algorithms can be used to determine a normal report situation and detect when a jammer makes the reports deviate from the normal situation. In one example, a convolutional neural network (CNN) may be used to detect jammers, while some examples may use a recurrent neural network (RNN) to exploit the time characteristics of the jammer by analyzing a sequence of reports and identifying a change of the reports rather than just trying to classify whether an individual report refers to jammed signals. RNNs may achieve better performance than CNNs, at the expense of more complexity and the analysis of batches of reports instead of individual reports.

Additionally, cloud implementation of the detection logic is possible. Cloud implementation has several advantages:
Data from multiple cells can be used for detection and positioning.
Data from multiple cells can be used to establish better jammer detectors, in particular training ML-based detectors.
More computational power is available allowing for more complex detector logic without overburdening the gNB.
Proprietary detection models are easier to protect in centralized locations.

However, one drawback with cloud implementation is that data compression/pre-processing need to be performed in the gNB to limit the burden on the backhaul/transport network.

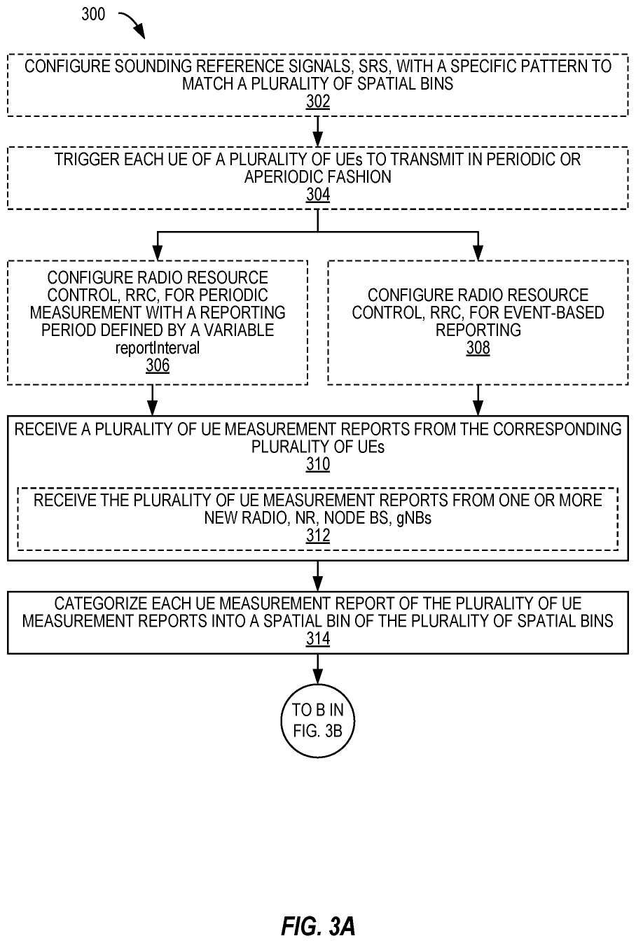

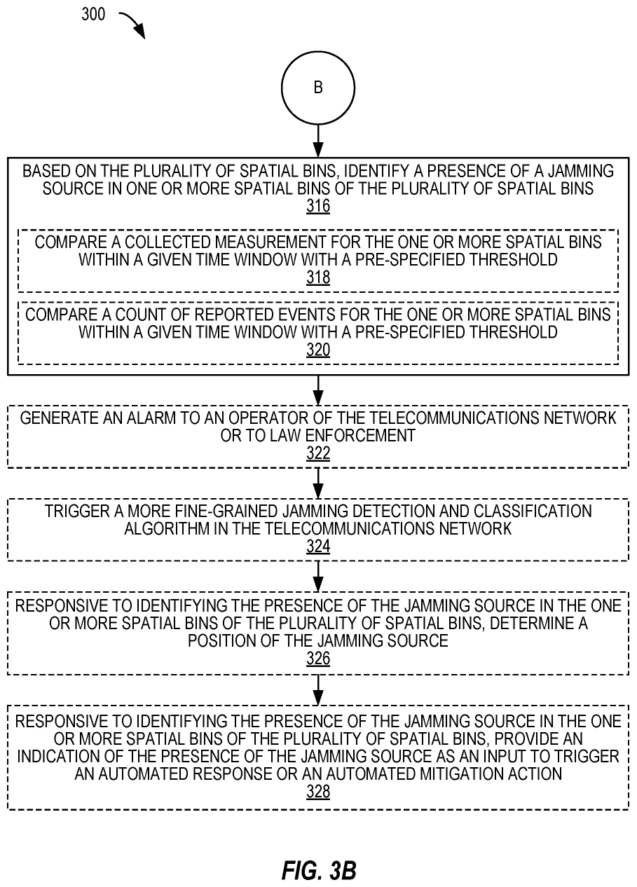

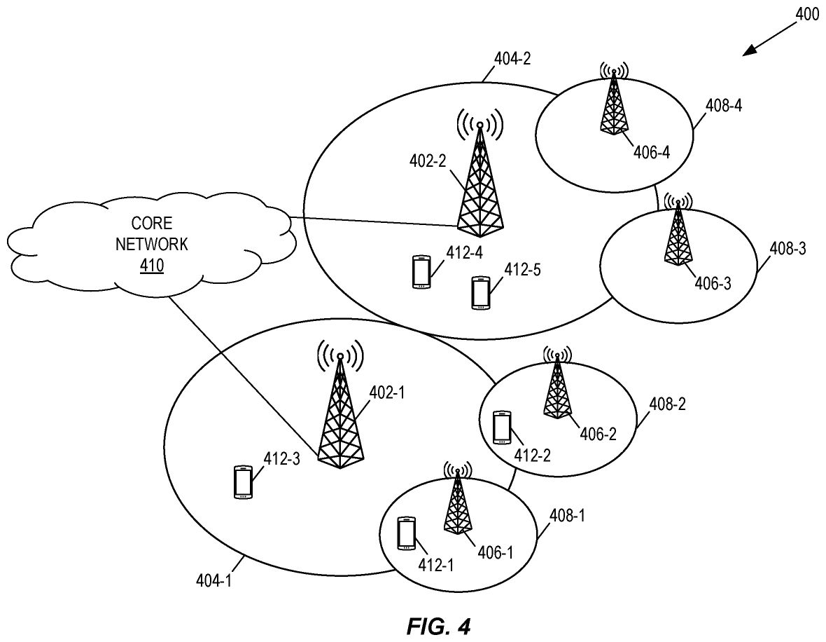

To illustrate exemplary operations for implementing UE-assisted jamming detection according to some examples, FIGS. 3A and 3B showing exemplary operations 300 are provided. It is to be understood that some of the exemplary operations 300 may be performed in an order other than that shown in FIGS. 3A and 3B, or may be omitted. The exemplary operations 300 in some examples begins in FIG. 3A with a network node, such as one of the network nodes 400 of FIG. 4, configuring SRS with a specific pattern to match a plurality of spatial bins (block 302). The network node in such examples may then trigger each UE of a plurality of UEs to transmit in periodic or aperiodic fashion (block 304). In some examples, the network node may configure RRC for periodic measurement with a reporting period defined by a variable reportInterval (block 306). Some examples may provide that the network node may configure RRC for event-based reporting (block 308).

The network node receives a plurality of UE measurement reports from the corresponding plurality of UEs (block 310). In some examples (e.g., those in which the network node implements a centralized detection system), the operations of block 310 for receiving the plurality of UE measurement reports may comprise the network node receiving the plurality of UE measurement reports from one or more gNBs (block 312). The network node then categorizes each UE measurement report of the plurality of UE measurement reports into a spatial bin of a plurality of spatial bins (block 314). The exemplary operations 300 then continue at block 316 of FIG. 3B.

Referring now to FIG. 3B, the exemplary operations 300 continue with the network node identifying a presence of a jamming source in one or more spatial bins of the plurality of spatial bins, based on the plurality of spatial bins (block 316). Some examples (e.g., those in which RRC is configured for periodic measurement) may provide that the operations of block 316 for identifying the presence of the jamming source may comprise comparing a collected measurement for the one or more spatial bins within a given time window with a pre-specified threshold (block 318). According to some examples (e.g., those in which RRC is configured for event-based reporting), the operations of block 316 for identifying the presence of the jamming source may comprise comparing a count of reported events for the one or more spatial bins within a given time window with a pre-specified threshold (block 320)

In some examples, after identifying the presence of the jamming source, the network node may generate an alarm to an operator of the telecommunications network or to law enforcement (block 322). Some examples may provide that the network node, upon identifying the presence of the jamming source, may trigger a more fine-grained jamming detection and classification algorithm in the telecommunications network (block 324). According to some examples, in response to identifying the presence of the jamming source in the one or more spatial bins of the plurality of spatial bins, the network node may determine a position of the jamming source (block 326). In some examples, in response to identifying the presence of the jamming source in the one or more spatial bins of the plurality of spatial bins, the network node may provide an indication of the presence of the jamming source as an input to trigger an automated response or an automated mitigation action (block 328).

FIG. 4 illustrates one example of a cellular communications system 400 in which embodiments of the present disclosure may be implemented. In the embodiments described herein, the cellular communications system 400 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 402-1 and 402-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 404-1 and 404-2. The base stations 402-1 and 402-2 are generally referred to herein collectively as base stations 402 and individually as base station 402. Likewise, the (macro) cells 404-1 and 404-2 are generally referred to herein collectively as (macro) cells 404 and individually as (macro) cell 404. The RAN may also include a number of low power nodes 406-1 through 406-4 controlling corresponding small cells 408-1 through 408-4. The low power nodes 406-1 through 406-4 can be small base stations (such as pico or femto base stations) or RRHs, or the like. Notably, while not illustrated, one or more of the small cells 408-1 through 408-4 may alternatively be provided by the base stations 402. The low power nodes 406-1 through 406-4 are generally referred to herein collectively as low power nodes 406 and individually as low power node 406. Likewise, the small cells 408-1 through 408-4 are generally referred to herein collectively as small cells 408 and individually as small cell 408. The cellular communications system 400 also includes a core network 410, which in the 5G System (5GS) is referred to as the 5GC. The base stations 402 (and optionally the low power nodes 406) are connected to the core network 410.

The base stations 402 and the low power nodes 406 provide service to wireless communication devices 412-1 through 412-5 in the corresponding cells 404 and 408. The wireless communication devices 412-1 through 412-5 are generally referred to herein collectively as wireless communication devices 412 and individually as wireless communication device 412. In the following description, the wireless communication devices 412 are oftentimes UEs, but the present disclosure is not limited thereto.

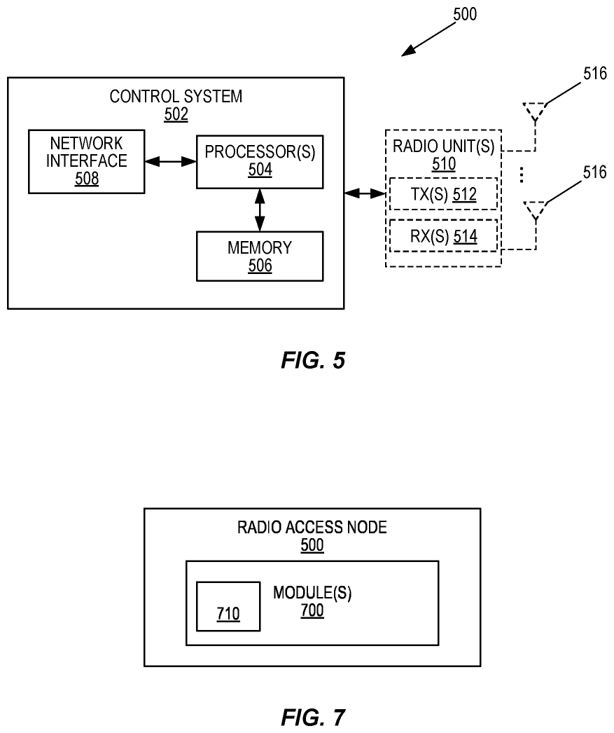

FIG. 5 is a schematic block diagram of a radio access node 500 according to some embodiments of the present disclosure. Optional features are represented by dashed boxes. The radio access node 500 may be, for example, a base station 402 or 406 or a network node that implements all or part of the functionality of the base station 402 or gNB described herein. As illustrated, the radio access node 500 includes a control system 502 that includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. In addition, the radio access node 500 may include one or more radio units 510 that each includes one or more transmitters 512 and one or more receivers 514 coupled to one or more antennas 516. The radio units 510 may be referred to or be part of radio interface circuitry. In some embodiments, the radio unit(s) 510 is external to the control system 502 and connected to the control system 502 via, e.g., a wired connection (e.g., an optical cable). However, in some other embodiments, the radio unit(s) 510 and potentially the antenna(s) 516 are integrated together with the control system 502. The one or more processors 504 operate to provide one or more functions of a radio access node 500 as described herein. In some embodiments, the function(s) are implemented in software that is stored, e.g., in the memory 506 and executed by the one or more processors 504.

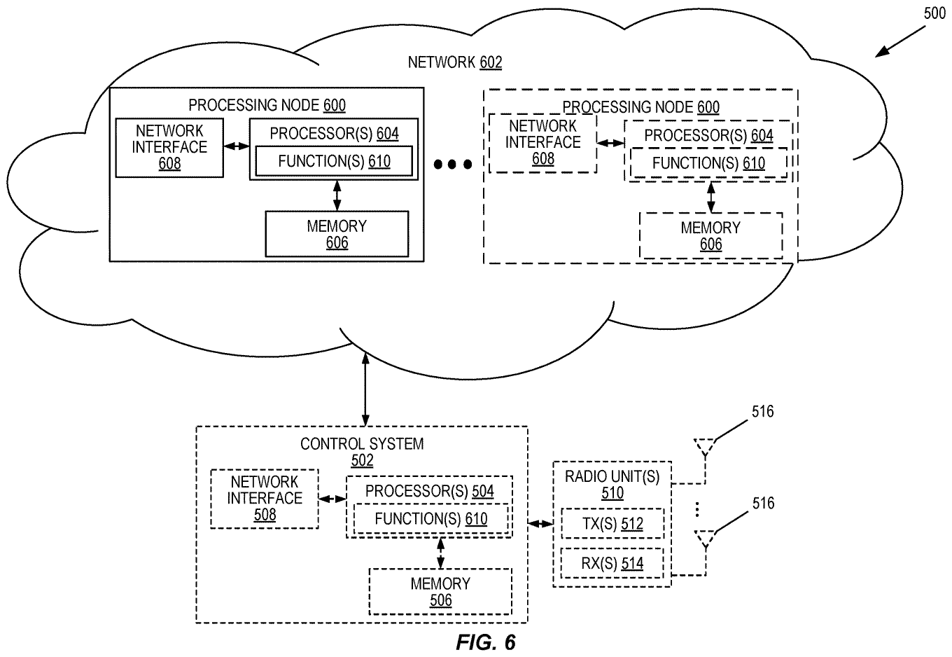

FIG. 6 is a schematic block diagram that illustrates a virtualized embodiment of the radio access node 500 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 500 in which at least a portion of the functionality of the radio access node 500 is implemented as a virtual component(s) (e.g., via a virtual machine(s) executing on a physical processing node(s) in a network(s)). As illustrated, in this example, the radio access node 500 may include the control system 502 and/or the one or more radio units 510, as described above. The control system 502 may be connected to the radio unit(s) 510 via, for example, an optical cable or the like. The radio access node 500 includes one or more processing nodes 600 coupled to or included as part of a network(s) 602. If present, the control system 502 or the radio unit(s) are connected to the processing node(s) 600 via the network 602. Each processing node 600 includes one or more processors 604 (e.g., CPUs, ASICs, FPGAS, and/or the like), memory 606, and a network interface 608.

In this example, functions 610 of the radio access node 500 described herein are implemented at the one or more processing nodes 600 or distributed across the one or more processing nodes 600 and the control system 502 and/or the radio unit(s) 510 in any desired manner. In some particular embodiments, some or all of the functions 610 of the radio access node 500 described herein are implemented as virtual components executed by one or more virtual machines implemented in a virtual environment(s) hosted by the processing node(s) 600. As will be appreciated by one of ordinary skill in the art, additional signaling or communication between the processing node(s) 600 and the control system 502 is used in order to carry out at least some of the desired functions 610. Notably, in some embodiments, the control system 502 may not be included, in which case the radio unit(s) 510 communicate directly with the processing node(s) 600 via an appropriate network interface(s).

In some embodiments, a computer program including instructions which, when executed by at least one processor, causes the at least one processor to carry out the functionality of radio access node 500 or a node (e.g., a processing node 600) implementing one or more of the functions 610 of the radio access node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the radio access node 500 according to some other embodiments of the present disclosure. The radio access node 500 includes one or more modules 700, each of which is implemented in software. The module(s) 700 provide the functionality of the radio access node 500 described herein. This discussion is equally applicable to the processing node 600 of FIG. 6 where the modules 700 may be implemented at one of the processing nodes 600 or distributed across multiple processing nodes 600 and/or distributed across the processing node(s) 600 and the control system 502. The UE-assisted jamming detection system 710 is here in the form of a software/computer program which comprises the modules 700 or a part of the modules 700.

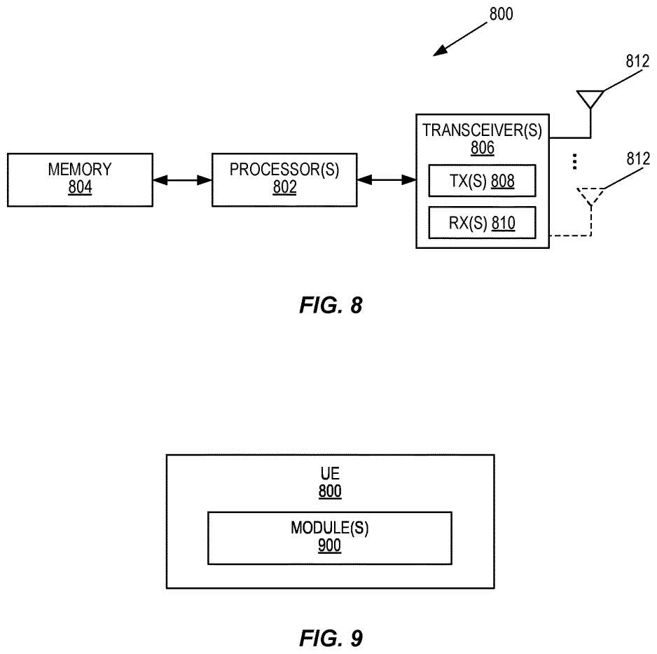

FIG. 8 is a schematic block diagram of a wireless communication device 800 according to some embodiments of the present disclosure. As illustrated, the wireless communication device 800 includes one or more processors 802 (e.g., CPUs, ASICS, FPGAs, and/or the like), memory 804, and one or more transceivers 806 each including one or more transmitters 808 and one or more receivers 810 coupled to one or more antennas 812. The transceiver(s) 806 includes radio-front end circuitry connected to the antenna(s) 812 that is configured to condition signals communicated between the antenna(s) 812 and the processor(s) 802, as will be appreciated by on of ordinary skill in the art. The processors 802 are also referred to herein as processing circuitry. The transceivers 806 are also referred to herein as radio circuitry. In some embodiments, the functionality of the wireless communication device 800 described above may be fully or partially implemented in software that is, e.g., stored in the memory 804 and executed by the processor(s) 802. Note that the wireless communication device 800 may include additional components not illustrated in FIG. 8 such as, e.g., one or more user interface components (e.g., an input/output interface including a display, buttons, a touch screen, a microphone, a speaker(s), and/or the like and/or any other components for allowing input of information into the wireless communication device 800 and/or allowing output of information from the wireless communication device 800), a power supply (e.g., a battery and associated power circuitry), etc.

In some embodiments, a computer program including instructions which, when executed by at least one processor, causes the at least one processor to carry out the functionality of the wireless communication device 800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the wireless communication device 800 according to some other embodiments of the present disclosure. The wireless communication device 800 includes one or more modules 900, each of which is implemented in software. The module(s) 900 provide the functionality of the wireless communication device 800 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| AMF | Access and Mobility Management Function |
| ASIC | Application Specific Integrated Circuit |
| AUSF | Authentication Server Function |
| CNN | Convolutional Neural Network |
| CPU | Central Processing Unit |
| CQI | Channel Quality information |
| CRI | Channel State Information Reference Signal |
| | Resource Indicator |
| CSI | Channel State Information |
| DSP | Digital Signal Processor |
| eNB | evolved Node B |
| E-UTRAN | Evolved Universal Mobile Telecommunications |
| | System Terrestrial Radio Access Network |
| FFT | Fast Fourier Transform |
| FPGA | Field Programmable Gate Array |
| gNB | NR Node B |
| HSS | Home Subscriber Server |
| IEEE | Institute of Electrical and Electronics Engineers |
| IoT | Internet of Things |
| KPI | Key Performance Indicator |
| LI | Layer Indicator |
| LTE | Long Term Evolution |
| ML | Machine Learning |
| MME | Mobility Management Entity |
| MTC | Machine Type Communication |
| multi-TRP | multiple Transmission Point |
| NEF | Network Exposure Function |
| NR | New Radio |
| PBCH | Physical Broadcast Channel |
| PM | Performance Management |
| PMI | Precoder Matrix Indicator |
| RAM | Random Access Memory |
| RAN | Radio Access Network |
| RI | Rank Indicator |
| RNN | Recurrent Neural Network |
| ROM | Read Only Memory |
| ROP | Report Output Period |
| RRC | Radio Resource Control |
| RRH | Remote Radio Head |
| RSRP | Reference Symbol Received Power OR |
| | Reference Signal Received Power |
| RSRQ | Reference Signal Received Quality OR |
| | Reference Symbol Received Quality |
| SDR | Software Defined Radio |
| SMF | Session Management Function |
| SS | Synchronization Signal |
| SSBRI | Synchronization Signal/Physical Broadcast |
| | Channel Resource Indicator |
| SSS | Secondary Synchronization Signal |
| TOF | Time of Flight |
| TS | Technical Specification |
| UE | User Equipment |
| UPF | User Plane Function |

Those skilled in the art will recognize improvements and modifications to the embodiments of the present disclosure. All such improvements and modifications are considered within the scope of the concepts disclosed herein.

1. A method performed by a network node implementing a User Equipment (UE) assisted jamming detection system of a telecommunications network, the method comprising:
receiving a plurality of UE measurement reports from a corresponding plurality of UEs, wherein each UE measurement report of the plurality of UE measurement reports comprises a signal-to-interference-and-noise ratio (SINR) measurement, or a cross-link interference (CLD); CH; measurement;
categorizing each UE measurement report of the plurality of UE measurement reports into a spatial bin of a plurality of spatial bins; and
based on the plurality of spatial bins, identifying a presence of a jamming source in one or more spatial bins of the plurality of spatial bins.

2. The method of claim 1, wherein the network node comprises a New Radio (NR) node B (gNB).

3. The method of claim 1, further comprising:
configuring sounding reference signals (SRS) with a specific pattern to match the plurality of spatial bins; and
triggering each UE of the plurality of UEs to transmit in periodic or aperiodic fashion.

4. The method of claim 1, wherein receiving the plurality of UE measurement reports from the corresponding plurality of UEs comprises receiving the plurality of UE measurement reports from one or more New Radio (NR) node Bs (gNBs).

5. The method of claim 1, wherein each UE measurement report of the plurality of UE measurement reports comprises the signal-to-interference-and-noise ratio (SINR) measurement calculated based on a secondary synchronization signal (SSS); or the SINR measurement based on a Channel State Information (CSI) reference signal.

6.-7. (canceled)

8. The method of claim 1, wherein categorizing each UE measurement report of the plurality of UE measurement reports into the spatial bin of a plurality of spatial bins is based on a serving cell of the UE, a sector of the UE, a beam of the UE, or a spatial position of the UE.

9. The method of claim 1, further comprising, responsive to identifying the presence of the jamming source in the one or more spatial bins of the plurality of spatial bins, generating an alarm to an operator of the telecommunications network or to law enforcement.

10. The method of claim 1, further comprising, responsive to identifying the presence of the jamming source in the one or more spatial bins of the plurality of spatial bins, triggering a more fine-grained jamming detection and classification algorithm in the telecommunications network.

11. The method of claim 1, further comprising, responsive to identifying the presence of the jamming source in the one or more spatial bins of the plurality of spatial bins, determining a position of the jamming source.

12. The method of claim 1, further comprising, responsive to identifying the presence of the jamming source in the one or more spatial bins of the plurality of spatial bins, providing an indication of the presence of the jamming source as an input to trigger an automated response or an automated mitigation action.

13. The method of claim 1, wherein identifying the presence of the jamming source in the one or more spatial bins of the plurality of spatial bins is based on a machine learning (ML) algorithm.

14. A network node implementing a User Equipment (UE) assisted jamming detection system of a telecommunications network, the network node comprising:
a network interface; and
processing circuitry associated with the network interface, the processing circuitry configured to cause the network node to:
receive a plurality of UE measurement reports from a corresponding plurality of UEs, wherein each UE measurement report of the plurality of UE measurement reports comprises a signal-to-interference-and-noise ratio (SINR) measurement, or a cross-link interference (CLI) measurement;
categorize each UE measurement report of the plurality of UE measurement reports into a spatial bin of a plurality of spatial bins; and
based on the plurality of spatial bins, identify a presence of a jamming source in one or more spatial bins of the plurality of spatial bins.

15. The network node of claim 14, wherein the network node comprises a New Radio (NR) node B (gNB).

16.-17. (canceled)

18. The network node of claim 14, wherein the processing circuitry is further configured to cause the network node to:
configure sounding reference signals (SRS) with a specific pattern to match the plurality of spatial bins; and
trigger each UE of the plurality of UEs to transmit in periodic or aperiodic fashion.

19. The network node of claim 14, wherein the plurality of UE measurement reports from the corresponding plurality of UEs are received from one or more New Radio (NR) node Bs (gNBs).

20. The network node of claim 14, wherein each UE measurement report of the plurality of UE measurement reports comprises the signal-to-interference-and-noise ratio (SINR) measurement calculated based on a secondary synchronization signal (SSS); or the SINR measurement based on a Channel State Information (CSI) reference signal.

21. The network node of claim 14, wherein categorizing each UE measurement report of the plurality of UE measurement reports into the spatial bin of a plurality of spatial bins is based on a serving cell of the UE, a sector of the UE, a beam of the UE, or a spatial position of the UE.

22. The network node of claim 14, wherein the processing circuitry is further configured to cause the network node to, responsive to identifying the presence of the jamming source in the one or more spatial bins of the plurality of spatial bins, generate an alarm to an operator of the telecommunications network or to law enforcement.

23. The network node of claim 14, wherein the processing circuitry is further configured to cause the network node to, responsive to identifying the presence of the jamming source in the one or more spatial bins of the plurality of spatial bins, trigger a more fine-grained jamming detection and classification algorithm in the telecommunications network.

24. The network node of claim 14, wherein the processing circuitry is further configured to cause the network node to, responsive to identifying the presence of the jamming source in the one or more spatial bins of the plurality of spatial bins, determine a position of the jamming source.
